(19) United States
(12) Patent Application Publication
(10) Pub. No.: US 2005/0054537 A1
(43) Pub. Date: Mar. 10, 2005

(54) Powder formulations

(76) Inventors: Hanns-Peter Muller, Odenthal (DE); Horst Gruttmann, Leverkusen (DE); Hilmar Wolf, Langenfeld (DE); Anne Suty-Heinze, Langenfeld (DE); Uwe Priesnitz, Solingen (DE)

Correspondence Address: BAYER CROPSCIENCE LP;Patent Department, 100 BAYER ROAD, PITTSBURGH, PA, 15205-9741, US

(21) Appl. No.: 10/500,821

(22) PCT Filed: Jan. 10, 2002
(86) PCT No.: PCT/EP02/14714

(30) Foreign Application Priority Data
Jan. 10, 2002 (DE) 102 00 603.2

(51) Int. Cl. A01N 25/10

(52) U.S. Cl. 504/360

(57) ABSTRACT

This invention relates to new powder formulations consisting of (a) at least one agrochemical active compound, (b) at least one biodegradable hydroxyl-containing polyester, optionally in a mixture with one or more further biodegradable polymers, and (c) optionally, additives, and which have a particle diameter of under 125 μm, and further relates to a process for the preparation of the new powder formulations and to their use for applying agrochemical active compounds to plants and/or their environment.

The present invention relates to new powder formulations comprising agrochemical active compounds and polymers, to a process for the preparation of these formulations, and to their use for applying agrochemical active compounds.

Microparticles containing specific polymers as a mixture with agrochemical active compounds are also known from WO 99-00 013. These preparations are made by dissolving polymers and agrochemical active compounds in an organic solvent which is sparingly miscible with water, then dispersing this solution in water using emulsifiers, thereupon evaporating the solvent, and separating the resulting microparticles from the aqueous phase by decanting and/or filtration and subsequently drying them. However, the disadvantage of this process is that a large number of complicated procedures have to be carried out and thus the use of relatively large apparatuses is necessary when carrying out the process on an industrial scale. The fact that the organic solvents required for dissolving the components must subsequently be removed is additionally disadvantageous.

Furthermore, U.S. Pat. No. 5,725,869 also describes methods for the preparation of polymer microparticles in which agrochemical active compounds are present. Again, these methods are very complicated and therefore hardly suitable for use on an industrial scale.

There have now been found new powder formulations consisting of
at least one agrochemical active compound,
at least one biodegradable hydroxyl-containing polyester, if appropriate in a mixture with one or more further biodegradable polymers, and,
if appropriate, additives
   and which have a particle diameter of under 125 μm.

It has furthermore been found that the powder formulations according to the invention can be prepared by homogenizing a mixture of
at least one agrochemical active compound,
at least one biodegradable hydroxyl-containing polyester, if appropriate in a mixture with one or more further biodegradable polymers, and,
if appropriate, additives
   at temperatures of between 50° C. and 180° C. in the melt and
   comminuting the mixture after cooling in such a way as to obtain a powder in which the particles have a diameter under 125 μm.

Finally, it has been found that the powder formulations according to the invention are highly suitable for applying the agrochemical active compounds which they contain to plants and/or their environment.

It must be considered as extremely surprising that the powder formulations according to the invention are more suitable for applying the agrochemical active compounds which they contain than the prior-art preparations of the most similar constitution. What is particularly unexpected is that the active components are released in the specifically desired amount over a prolonged period.

Furthermore, it had to be assumed that carrying out the process according to the invention would, after cooling of the melt, result in soft resins which are sticky at room temperature since mixtures of polyesters and agrochemical active compounds generally have low melting points. However, in contrast to what was expected, products are obtained which are so brittle that they can be comminuted with the aid of customary mills without additional cooling to give free-flowing powders which do not form aggregates.

The powder formulations according to the invention contain one or more agrochemical active compounds.

Agrochemical active compounds are understood as meaning; for the present purpose, all substances which are customary for the treatment of plants. Substances which may preferably be mentioned are fungicides, bactericides, insecticides, acaricides, nematicides, herbicides, plant growth regulators, plant nutrients and repellents. Solid agrochemical active compounds are preferred.

Examples of fungicides which may be mentioned are:
2-anilino-4-methyl-6-cyclopropylpyrimidine; 2′,6′-dibromo-2-methyl-4′-trifluoro-methoxy-4′-trifluoromethyl-1,3-thiazole-5-carboxanilide; 2,6-dichloro-N-(4-trifluoro-methylbenzyl)benzamide; (E)-2-methoximino-N-methyl-2-(2-phenoxyphenyl)acetamide; 8-hydroxyquinoline sulphate; methyl (E)-2-{2-[6-(2-cyanophenoxy)-pyrimidin-4-yloxy]phenyl}-3-methoxyacrylate; methyl (E)-rnethoximino[alpha-(o-tolyloxy)-o-tolyl]acetate; 2-phenylphenol (OPP), aldimorph, ampropylfos, anilazin, azaconazol,
benalaxyl, benodanil, benomyl, binapacryl, biphenyl, bitertanol, blasticidin-S, bromuconazole, bupirimate, buthiobate,
calcium polysulphide, captafol, captan, carbendazim, carboxin, quinomethionate, chloroneb, chloropicrin, chlorothalonil, chlozolinate, cufraneb, cymoxanil, cyproconazole, cyprofuram, carpropamid,
dichlorophen, diclobutrazol, dichlofluanid, diclomezine, dicloran, diethofencarb, difenoconazole, dimethirimol, dimethomorph, diniconazole, dinocap, diphenylamine, dipyrithion, ditalimfos, dithianon, dodine, drazoxolon, edifenphos, epoxyconazole, ethirimol, etridiazole,
fenarimol, fenbuconazole, fenfuram, fenitropan, fenpiclonil, fenpropidin, fenpropimorph, fentin acetate, fentin hydroxide, ferbam, ferimzone, fluazinam, fludioxonil, fluoromide, fluquinconazole, flusilazole, flusulfamide, flutolanil, flutriafol, folpet, fosetyl-aluminium, fthalide, fuberidazol, furalaxyl, furmecyclox, fenhexamid,
guazatine,
hexachlorobenzene, hexaconazole, hymexazol,
imazalil, imibenconazole, iinoctadine, iprobenfos (IBP), iprodione, isoprothiolan, iprovalicarb,
kasugamycin, copper, preparations such as: copper hydroxide, copper naphthenate, copper oxychloride, copper sulphate, copper oxide, oxine-copper and Bordeaux mixture,
mancopper, mancozeb, maneb, mepanipyrim, mepronil, metalaxyl, metconazole, methasulfocarb, methfuroxam, metiram, metsulfovax, myclobutanil,
nickel dimethyldithiocarbamate, nitrothal-isopropyl, nuarimol,
ofurace, oxadixyl, oxamocarb, oxycarboxin,
pefurazoate, penconazole, pencycuron, phosdiphenr, pimaricin, piperalin, polyoxin, probenazole, prochloraz, procymidon, propamocarb, propiconazole, propineb, pyra-zophos, pyrifenox, pyrimethanil, pyroquilon,
quintozene (PCNB), quinoxyfen,
sulfur and sulfur preparations, spiroxamine,
tebuconazole, tecloftalam, tecnazene, tetraconazole, thiabendazole, thicyofen, thio-phanate-methyl, thiram, tolclophos-methyl, tolylfluanid, triadimefon, triadimenol, triazoxide, trichlamide, tricyclazole, tridemorph, triflumizole, triforine, triticonazole, trifloxystrobin,
validamycin a, vinclozolin,
zineb, ziram, and
2-[2-(1-chlorocyclopropyl)-3-(2-chlorophenyl)-2-hydroxypropyl]-2,4-dihydro-[1,2,4]-triazole-3-thione.

Examples of bactericides which may be mentioned are:
bronopol, dichlorophen, nitrapyrin, nickel dimethyldithiocarbamate, kasugamycin, octhilinone, furancarboxylic acid, oxytetracyclin, probenazole, streptomycin, tecloftalam, copper sulphate and other copper preparations.

Examples of insecticides, acaridices and nematicides which may be mentioned are:
abamectin, acephate, acrinathrin, alanycarb, aldicarb, alphamethrin, amitraz, avermectin, AZ 60541, azadirachtin, azinphos A, azinphos M, azocyclotin,
Bacillus thuringiensis, 4-bromo-2-(4-chlorophenyl)-1-(ethoxymethyl)-5-(trifluoromethyl)-1H-pyrrole-3-carbonitrile, bendiocarb, benfuracarb, bensultap, betacyfluthrin, bifenthrin, BPMC, brofenprox, bromophos A, bufencarb, buprofezin, butocarboxin, butylpyridaben,
cadusafos, carbaryl, carbofuran, carbophenothion, carbosulfan, cartap, chloethocarb, chloretoxyfos, chlorfenvinphos, chlorfluazuron, chlormephos, N-[(6-chloro-3-pyridinyl)-methyl]-N′-cyano-N-methyl-ethaniridamide, chlorpyrifos, chlorpyrifos M, cis-resmethrin, clocythrin, clofentezine, cyanophos, cycloprothrin, cyfluthrin, cyhalothrin, cyhexatin, cypermethrin, cyromazine,
deltamethrin, demeton-M, demeton-S, demeton-S-methyl, diafenthiuron, diazinon, dichlofenthion, dichlorvos, dicliphos, dicrotophos, diethion, diflubenzuron, dimethoate,
dimethylvinphos, dioxathion, disulfoton,
emamectin, esfenvalerate, ethiofencarb, ethion, ethofenprox, ethoprophos, etrimphos, fenamiphosi, fenazaquin, fenbutatin oxide, fenitrothion, fenobuicarb, fenothiocarb, fenoxycarb, fenpropathrin, fenpyrad, fenpyroximate, fenthion, fenvalerate, fipronil, fluazuron, flucycloxuron, flucythrinate, flufenoxuroni, flufenprox, fluvalinate, fono-phos, formothion, fosthiazate, fubfenprox, furathiocarbi,
HCH, heptenophos, hexaflumuron, hexythiazox,
imidacloprid, iprobenfos, isazophos, isofenphos, isoprocarb, isoxathion, ivermectin, lambda-cyhalothrin, lufenuron,
malathion, mecarbam, mevinphos, mesulfenphos, metaldehyde, methacrifosi, metha-midophos, methidathion, methiocarb, methomyl, metolcarb, milbemectin, mono-crotophos, moxidectin,
naled, NC 184, nitenpyram,
omethoate, oxamyl, oxydemethon M, oxydeprofos,
parathion A, parathion M, permethrin, phenthoate, phorate, phosalone, phosmet, phosphamidon, phoxim, pirimicarb, pirirniphos M, pirimiphos A, profenophos, promecarb, propaphos, propoxur, prothiophos, prothoate, pymetrozin, pyrachlophos, pyridaphenthion, pyresmethrin, pyrethrum, pyridaben, pyrimidifen, pyriproxifen,
quinalphos,
salithion, sebufos, silafluofen, sulfotep, sulprofos,
tebufenozide, tebufenpyrad, tebupirirniphos, teflubenzuron, tefluthrin, temephos, terbam, terbufos; tetrachlorvinphob viicloprid, rthiafenox, thiamethoxam, thiodicarb, thiofanox, thiomethon, thionazin, thuringiensin, tralomethrin, transfluthrin, triarathen, triazophos, triazuron, trichlorfon, triflumuron, trimethacarb,
vamidothion, XMC, xylylcarb, zetamethrin.

Examples of herbicides which may be mentioned are:
anilides such as, for example, diflufenican and propanil; arylcarboxylic acids, such as, for example, dichloropicolinic acid, dicamba and picloram; aryloxyalkanoic acids such as, for example, 2,4-D, 2,4-DB, 2,4-DP, fluroxypyr, MCPA, MCPP and triclopyr; aryloxyphenoxyalkanoic esters such as, for example, diclofop-methyl, fenoxaprop-ethyl, fluazifop-butyl, haloxyfop-methyl and quizalofop-ethyl; azinones such as, for example, chloridazon and norflurazon; carbamates such as, for example, chlorpropham, desmedipham, phenmedipham and propham; chloroacetanilides such as, for example, alachlor, acetochlor, butachlor, metazachlor, metolachlor, pretilachlor and propachlor; dinitroanilines such as, for example, oryzalin, pendimethalin and trifluralin; diphenyl ethers such as, for example, acifluorfen, bifenox, fluoroglycofen, fomesafen, halosafen, lactofen and oxyfluorofen; ureas such as, for example, chlortoluron, diuron, fluometuron, isoproturon, linuron and metha-benzthiazuron; hydroxylamines such as, for example, alloxydim, clethodim, cycloxydim, sethoxydim and tralkoxydim; imidazolinones such as, for example, imazethapyr, imazamethabenz, imazapyr and imazaquin; nitriles such as, for example, bromoxynil, dichlobenil and ioxynil; oxyacetamides such as, for example, mefenacet; sulphonylureas such as, for example, amidosulfuron, bensulfuron-methyl, chlorimuron-ethyl, chlorsulfuron, cinosulfuron, metsulfuron-methyl, nicosulfuron, primisulfuron, pyrazosulfuron-ethyl, thifensulfuron-methyl, triasulfuron and tribenuron-methyl; thiocarbamates such as, for example, butylate, cycloate, di-allate, EPTC, esprocarb, molinate, prosulfocarb, thiobencarb and tri-allate; triazines such as, for example, atrazine, cyanazine, simazine, simetryne, terbutryne and terbutylazine; triazinones such as, for example, hexazinon, metamitron and metribuzin; others such as, for example, aminotriazole, benfuresate, bentazone, cinmethylin, clomazone, clopyralid, difenzoquat, dithiopyr, ethofumesate, fluorochloridone, glufosinate, glyphosate, isoxaben, pyridate, quinchlorac, quinmerac, sulphosate and tridiphane. Others which may be mentioned are 4-amino-N-(1,1-dimethylethyl)-4,5-dihydro-3-(1-metylethyl)-5-oxo-1H-1,2,4-triazole-1-carb-oxamide and methyl 2-((((4,5-dihdydro-4-methyl-5-oxo-3-propoxy-1H-1,2,4-triazol-1-yl)carbonyl)amino)sulphonyl)benzoate.

Examples of plant growth regulators which may be mentioned are chlorcholin chloride and ethephon.

Examples of plant nutrients which may be mentioned are customary inorganic or organic fertilizers for providing plants with macro- and/or micronutrients.

Examples of repellents which may be mentioned are diethyltoluamide, ethylhexanediol and butopyronoxyl.

Examples which may be mentioned of insecticides which may preferably be present in the powder formulations according to the invention are the following active compounds:
imidacloprid, thiacloprid, thiamethoxam, acetamiprid, clothianidin, betacyfluthrin, cypermethrin, transfluthrin, lambda-cyhalothrin and azinphos-methyl.

Examples which may be mentioned of herbicides which can preferably be present in the powder formulations according to the invention are the following active compounds:
propoxycarbazone-sodium, flucarbazone-sodium, amicarbazone, dichlobenil and phenyluracils of the formula

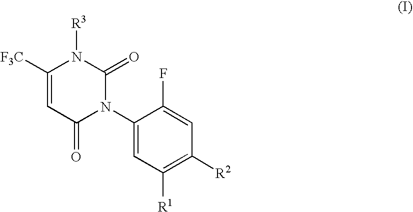

in which the substituents R¹, R² and R³ have the meanings stated hereinbelow.

| R¹ | R² | R³ |
|---|---|---|
| 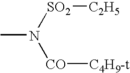 | —CN | —CH₃ |
| 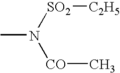 | —CN | —CH₃ |
| 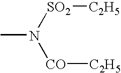 | —CN | —CH₃ |
| 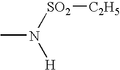 | 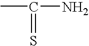 | —CH₃ |
| 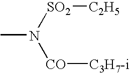 | —CN | —CH₃ |
| 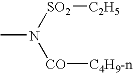 | —CN | —CH₃ |
| 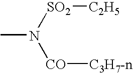 | —CN | —CH₃ |
| 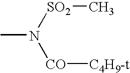 | —CN | —CH₃ |
| 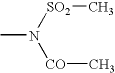 | —CN | —CH₃ |
| 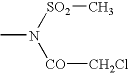 | —CN | —CH₃ |
| 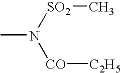 | —CN | —CH₃ |
| 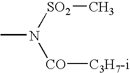 | —CN | —CH₃ |
| 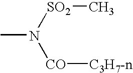 | —CN | —CH₃ |
| 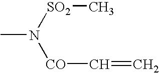 | —CN | —CH₃ |
| 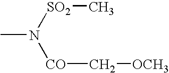 | —CN | —CH₃ |
| 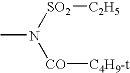 | —CN | —NH₂ |
| 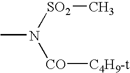 | —CN | —NH₂ |

The powder formulations according to the invention contain one or more biodegradable hydroxyl-containing polyesters, if-appropriate in a mixture with one or more further biodegradable polymers.

Polyesters which are preferably suitable are those-esters which are derived from aliphatic, cycloaliphatic, aromatic and/or heterocyclic saturated or unsaturated carboxylic acids which can be substituted by halogen atoms. Examples which may be mentioned are:
succinic acid, adipic acid, suberic acid, azelaic acid, sebacic acid, phthalic acid, terephthalic acid, isophthalic acid, trimellithic acid, pyromellithic acid, tetra-hydrophthalic acid, hexahydrophthalic acid, endomethylenetetrahydrophthalic acid, glutaric acid, maleic acid, fumaric acid and—if obtainable—their anhydrides,
furthermore dimeric and trimeric fatty acids such as oleic acid, if appropriate in a mixture with monomeric fatty acids,
moreover dimethyl terephthalate, bisglycol terephthalate,
furthermore cyclic monocarboxylic acids such as benzoic acid, p-tert-butylbenzoic acid or hexahydrobenzoic acid.

Suitable alcohol components from which the polyesters are derived are, preferably, polyhydric alcohols such as ethylene glycol, 1,2-propylene glycol, 1,3-propylene glycol, 1,4-butylene glycol, 2,3-butylene glycol, di-β-hydroxyethyl-butanediol, 1,6-hexanediol, 1,8-octanediol, neopentyl glycol, cyclohexanediol, 1,4-bis-(hydroxymethyl)cyclohexane, 2,2-bis(4-hydroxycyclohexyl)propane, 2,2-bis(4-(β-hydroxyethoxy)phenyl)propane, 2-methyl-1,3-propanediol, glycerol, trimethylolpropane, 1,2,6-hexanetriol, 1,4-butanediol, tris(β-hydroxyethyl)-isocyanurate, trimethylolethane, pentaerythritol, quinitol, mannitol and sorbitol, formitol and their hydroxyalkylation products, methyl glycol, diethylene glycol, triethylene glycol, tetraethylene glycol, dipropylene glycol, tripropylene glycol, dibutylene glycol, polybutylene glycols and xylylene glycol.

Others which may also be present in minor quantities are mono- or polyesters of lactones, such as ε-caprolactone, or of hydroxycarboxylic acids, such as hydroxypivalic acid, hydroxydecanoic acid or hydroxycaproic acid, furthermore polyesters of the abovementioned polycarboxylic acids and/or their derivatives and polyphenols such as hydroquinone, bisphenol-A, 4,4′-dihydroxybiphenyl or bis(4-hydroxyphenyl) sulphone; polyesters modified with fatty acid (oil alkyds) and naturally occurring saturated or unsaturated polyesters, their degradation products or transesterification products with polyols such as castor oil, tall oil, soya oil, linseed oil; carbonic acid polyesters which are obtainable from hydroquinone, diphenylolpropane, p-xylylene glycol, ethylene glycol, butanediol or 1,6-hexanediol and other polyols by customary condensation reactions, for example with phosgene or diethyl carbonate or diphenyl carbonate, or from cyclic carbonates such as glycol carbonate or vinylidene carbonate; silic acid polyesters, polysiloxanes such as, for example, the products which can be obtained by hydrolyzing dialkyldichlorosilanes with water and subsequently treating the product with polyalcohols or which can be obtained by an addition reaction of polysiloxane dihydrides and olefins such as allyl alcohol or acrylic acid.

Other suitable polyesters are reaction products of mono-, di- or polycarboxylic acids and glycidyl compounds as are described, for example, in DIE-A 24 10 513.

Examples of glycidyl compounds are esters of 2,3-epoxy-1-propanol with monobasic acids having 4 to 18 carbon atoms, such as glycidyl palmitate, glycidyl laurate and glycidyl stearate; alkylene oxides having 4 to 18 carbon atoms such as butylene oxide and glycidyl ethers, such as octyl glycidyl ether.

Examples of di- and polycarboxylic acids are the substances mentioned in the list hereinbelow under item 2.

Examples of monocarboxylic acids are the substances mentioned in the list hereinbelow under item 3.

Other preferred polyesters in the case of the powder formulations according to the invention are monomeric esters such as bis(hydroxyalkyl) carboxylate, furthermore monocarboxylic esters of more than dihydric polyols, and also oligoesters which can be prepared by subjecting alcohols and carboxylic acids to condensation reactions, as they are mentioned in the list hereinbelow.

List of suitable starting materials.
1. Alcohols having 2 to 24, preferably 2 to 10, carbon atoms, and 2 to 60H groups bonded to nonaromatic carbon atoms, for example ethylene glycol, propylene glycols, diethylene glycol, dipropylene glycol, butanediols, neopentyl glycol, hexanediols, hexanetriols, perhydrobisphenol, dimethylolcyclohexane, glycerol, trimethylolethane, trimethylolpropane, pentaerythritol, dipentaerythritol, mannitol;
2. di- and polycarboxylic acids having 4 to 36 carbon atoms and 2 to 4 carboxyl groups, and their esterifiable derivatives such as anhydrides and esters, for example phthalic acid(anhydride), isophthalic acid, terephthalic acid, alkyltetrahydrophthalic acid, endomethylenetetrahydrophthalic anhydride, adipic acid, succinic acid, maleic acid, fumaric acid, dimeric fatty acids, trimellithic acid, pyromellithic acid, azelaic acid;
3. monocarboxylic acids having 6 to 24 carbon atoms, for example caprylic acid, 2-ethylhexanoic acid, benzoic acid, p-tert-butylbenzoic acid, hexahydrobenzoic acid, monocarboxylic acid mixtures of natural oils and fats such as coconut oil fatty acid, soya oil fatty acid, recinene fatty acid, hydrogenated and isomerized fatty acids such as “conjuvandol” fatty acid, and mixtures of these, it also being possible to employ the fatty acids as glycerides and to react them with transesterification and/or dehydration;
4. monohydric alcohols having 1 to 18 carbon atoms, for example methanol, ethanol, isopropanol, cyclohexanol, benzyl alcohol, isodecanol, nonanol, octanol, oleyl alcohol, octadecanol.

Especially preferred are hydroxyl-containing terephthalic acid polyesters whose average molecular weight is between 1 000 g/mol and 20 000 g/mol, preferably between 1 500 g/mol and 15 000 g/mol, based on the number average molecular weight.

The hydroxyl-containing polyesters which are present in the powder formulations according to the invention generally have an OH functionality of ≧2 to ≦7, preferably 2.1 to 4.5, hydroxyl numbers of between 20 and 120 mg KOH/g, preferably between 30 and 100 mg KOH/g, viscosities of <100 000 mPa.s, preferably <40 000 mPa.s at 160° C. and melting points of from ≧65° C. to ≦130° C., preferably 75° C. to 100° C.

The polyesters which are present in the powder formulations according to the invention are known or can be prepared in a simple manner by customary methods.

Thus, such polyesters are obtained, for example, by subjecting the starting materials in question to a condensation reaction under an inert gas atmosphere at temperatures of between 100° C. and 260° C., preferably between 130° C. and 220° C., in the melt or using solvents with azeotropic removal of water (cf. Houben-Weyl “Methoden der Organischen Chemie” [Methods in Organic Chemistry], Vol. 14/2, pages 1 to 4, 21 to 23 and 44 to 46, Georg Thieme Verlag, Stuttgart 1963, and C. R. Martens “Alkyd Resins”, pages 51 to 59, Reinhold Plastics Appln. Series, Reinhold Publishing Comp., New York 1961).

Suitable additional polymers which may be present in the powder formulations according to the invention are acrylate resins which can be obtained, for example, from the monomers listed hereinbelow by homo- or copolymerization.

Esters of acrylic acid and methacrylic acid with dihydric, saturated, aliphatic alcohols having 2 to 4 carbon atoms, such as, for example, 2-hydroxyethylacrylate, 2-hydroxypropyl acrylate, 4-hydroxybutyl acrylate and the corresponding methacrylic esters; acrylic esters and methacrylic esters having 1 to 18, preferably 1 to 8, carbon atoms in the alcohol moiety such as, for example, methyl acrylate, ethyl acrylate, propyl acrylate, isopropyl acrylate, n-butyl acrylate, tert-butyl acrylate, 2-ethylhexyl acrylate, stearyl acrylate, and the corresponding methacrylic esters, cyclohexyl acrylate and cyclohexyl methacrylate; acrylonitrile and methacrylonitrile; acrylamide and methacrylamide; N-methoxymethyl(meth)acrylamide.

Preferred acrylate resins are copolymers of
a) 0 to 50% by weight of monoesters of acrylic acid or methacrylic acid with two- or polyhydric alcohols, such as 1,4-butanediol monoacrylate, hydroxypropyl (meth)acrylate; furthermore vinyl glycol, vinylthioethanol, allyl alcohol, 1,4-butanediol monovinyl ether;
b) 5 to 95% by weight of esters of acrylic acid or methacrylic acid with monohydric alcohols containing 1 to 12 carbon atoms, such as, for example, methyl methacrylate, ethyl acrylate, n-butyl acrylate or 2-ethylhexyl acrylate;
c) 0 to 50% by weight of aromatic vinyl compounds, such as styrene, methylstyrene or vinyltoluene;
d) 0 to 20% by weight of other monomers with functional groups such as, for example, acrylic acid, methacrylic acid, crotonic acid, itaconic acid, maleic acid, fumaric acid, maleic anhydride, maleic monoester, acrylamide, methacrylamide, acrylonitrile or N-methylol(meth)acrylamide and glycidyl (meth)acrylate, the content of group a) and/or d) amounting to at least 5% by weight.

The abovementioned acrylate resins are known or can be prepared in a simple manner by customary methods. Thus, such acrylate resins are obtained, for example, by solvent polymerization, bead polymerization, emulsion polymerization or precipitation polymerization, but preferably by mass polymerization, which, in turn, can be initiated by UV light or other polymerization initiators. Suitable polymerization initiators are peroxides- or azo compounds such as, for example, dibenzoyl peroxide, tert-butyl perbenzoate or azodiisobutyronitrile. The molecular weight can be adjusted for example using sulphur compounds such as tert-dodecylmercaptan.

Naturally, mixtures of a plurality of substances may be employed as polyhydroxyl compounds.

Suitable esterification catalysts are inorganic oxides and salts of tin, zinc, manganese, titanium and bismuth. Organotin compounds such as, for example, tin(II) acetate, tin(II) octoate, tin(II) laurate, dibutyltin diacetate, dibutyltin dilaurate, dibutyltin maleate or dioctyltin diacetate may likewise be used as catalysts. In general, the catalysts are employed in an amount of between 0.01 and 0.5% by weight based on the total amount of the reactants used.

Polyesters which are present in the powder formulations according to the invention are especially preferably esters which are derived from the acids and alcohols listed hereinbelow.

Especially preferred alcohols are glycols such as ethylene glycol, 1,2-propanediol, 1,4-butanediol and isomers, furthermore neopentyl glycol, 1,6-hexanediol and isomers, 4,4′-dihydroxydicyclohexyl-2,2-propane, cyclohexanediol, 1,4-bis-(hydroxymethyl)cyclohexane, and furthermore polyols such as trimethylolpropane, hexanetriol and pentaerythritol.

Especially preferred acids are di- or polycarboxylic acids such as terephthalic acid, tetrahydrophthalic acid, phthalic acid, isophthalic acid, trimellithic and adipic acid.

Especially preferred are hydroxyl-containing polyesters comprising
50 to 65% by weight of aromatic polycarboxylic acids,
30 to 45% by weight of aliphatic glycols and
0 to 5% by weight of aliphatic triols.

Polymers which are optionally additionally present are hydroxyl-containing copolymers as are formed by copolymerization of hydroxyalkyl acrylates or hydroxyalkyl methacrylates with acrylic esters or methacrylic esters and, if appropriate, further unsaturated monomers. Unsaturated monomers are, in this context, for example substances obtainable from styrene/maleic acid copolymerization by partial esterification of the acid groups with ethylene oxide (cf. DE-A 21 37 239).

The softening points measured, by differential thermoanalysis (=DTA) of the preferred hydroxyl-containing polyesters are generally between 40° C. and 140° C., preferably between 45° C. and 100° C. The hydroxyl numbers of these materials are generally between 25 and 200, preferably between 30 and 130. The molecular weight of these materials which can be calculated from the functionality and the hydroxyl content is generally between 400 and 10 000, preferably between 1 000 and 5 000.

Suitable additives which may be present in the plant treatment compositions according to the invention are all of the materials which can conventionally be employed in such polymer preparations. Preferably suitable are fillers, and lubricants, glidants and stabilizers known from polymer technology.

Examples of fillers which may be mentioned are: titanium dioxide, barium sulphate, furthermore aluminium oxides, silicas, clays, precipitated or colloidal silicon dioxide, and phosphates.

Examples of lubricants and glidants which may be mentioned are: magnesium stearate, stearic acid, talc and bentonites.

Suitable stabilizers are antioxidants and substances which protect the polymers from undesired degradation during processing.

The concentrations of the individual components in the powder formulations according to the invention can be varied within a substantial range. Thus,
the content of agrochemical active compounds is generally between 1 and 50% by weight, preferably between 5 and 40% by weight, the content of hydroxyl-containing polyesters, if appropriate in a mixture with additional polymers, is generally between 50 and 99% by weight, preferably between 55 and 95% by weight, and the additive content is generally between 0 and 30% by weight, preferably between 0 and 20% by weight.

When carrying out the process according to the invention, a procedure is generally followed in which the polymer components are melted at temperatures of between 50° C. and 180° C., preferably between 120° C. and 180° C., especially preferably between 140° C. and 170° C., and one or more agrochemical active compounds and, if appropriate, additives are then introduced with stirring. The resulting fluid and homogeneous mixture is transported to cooling belts or cooling drums with the aid of customary discharge devices. When cold, the solidified product is removed from the cooling device and crushed. The crude granules obtained are subsequently comminuted with customary grinding apparatuses and screened to give a powder in which the particles have a diameter of under 125 μm.

Suitable grinding apparatuses are all mills which are conventionally employed for such purposes. Mills which can preferably be used are pinned-disc mills, ball mills, jet mills or classifier mills, a mill which may be mentioned by way of example being an ACM 2 type mill from Hosokawa Mikropul.

The powder formulations according to the invention, as such or after addition of further formulation auxiliaries, can be employed for applying agrochemical active compounds in crop protection in agriculture, forestry or horticulture. Formulation auxiliaries which are suitable in this context are all those components which can generally be used in plant treatment compositions such as, for example, colorants, wetters, dispersants, emulsifiers, antifoams, preservatives, humectant components, antifreeze agents, secondary thickeners, solvents, and, when seed-dressing products are prepared, also stickers.

Colorants which can be employed for the further processing of the powders according to the invention as plant treatment compositions are all those colorants which are customary for such purposes. Colorants which can be used are sparingly water-soluble pigments and also water-soluble dyes. Examples which may be mentioned are those known under the names Rhodamin B, C.I.Pigment Red 112 and C.I.Solvent Red 1.

Suitable wetters which can be used for formulating the powders according to the invention are all those materials which promote wetting and which are customary for the formulation of agrochemical active compounds. Materials which can preferably be used are alkylnaphthalenesulphonates, such as diisopropylnaphthalenesulphonate or diisobutylnaphthalenesulphonate.

Dispersants and/or emulsifiers which are suitable for formulating the powders according to the invention are all those nonionic, anionic and cationic dispersants which are conventionally used in the formulation of agrochemical active compounds. Materials which can preferably be used are nonionic or anionic dispersants or mixtures of nonionic or anionic dispersants. Suitable nonionic dispersants which may be mentioned are, in particular, ethylene oxide/propylene, oxide block polymers, alkylphenol polyglycol ethers and tristyrylphenol polyglycol ethers, and their phosphated or sulphated derivatives. Suitable anionic dispersants are, in particular, lignosulphonates, polyacrylic acid salts and arylsulphonate/formaldehyde condensates.

Antifoams which can be used for formulating the powders according to the invention are, all those materials which inhibit foaming and which are suitable for the formulation of agrochemical active compounds. Materials which can preferably be used are silicon antifoams and magnesium stearate.

Preservatives which can's be used for formulating the powders according to the invention are all those substances which are conventionally used for such purposes for the formulation of agrochemical active compounds. Examples which may be mentioned are dichlorophene and benzyl alcohol hemiformal.

Possible humectant components and antifreeze agents which can be used for formulating the powders according to the invention are all those materials which can be employed for such purposes in agrochemical compositions. Substances which can preferably be used are polyhydric alcohols such as glycerol, ethanediol, propanediol and polyethylene glycols of various molecular weights.

Suitable secondary thickeners which can be used for formulating the powders according to the invention are all substances which can be employed for such purposes in agrochemical compositions. Possible substances are, preferably, cellulose derivatives, acrylic acid derivatives, xanthan, modified clays and highly dispersed silica.

Possible solvents which can be used for formulating the powders according to the invention are all organic solvents which can be employed in agrocheniucal compositions. Substances which are preferably suitable are ketones such as methyl isobutyl ketone and cylohexanone, furthermore amides, such as dimethylformamide, moreover cyclic compounds such as N-methyl-pyrrolidone, N-octyl-pyrrolidone, N-dodecyl-pyrrolidone, N-octyl-caprolactam, N-dodecyl-caprolactam and γ-butyrolactone, in addition strongly polar solvents such as dimethylsulfoxide, furthermore aromatic hydrocarbons such as xylene, or else esters such as propylene glycol monomethyl ether acetate, dibutyl adipate, hexyl acetate, heptyl acetate, tri-n-butyl citrates, diethyl phthalate and di-n-butyl phthalate, and, moreover, alcohols such as ethanol, n- and i-propanol, n- and i-butanol, n- and i-amyl alcohol, benzyl alcohol and 1-methoxy-2-propanol. Water may also be employed as diluent.

If it is intended to prepare seed-dressing products, stickers may also be employed for formulating the powders according to the invention. Suitable materials are all customary binders which can be employed in seed-dressing products. Materials which may preferably be mentioned are polyvinylpyrrolidone, polyvinyl acetate, polyvinyl alcohol and tylose.

Especially preferred as stickers are also dispersions of biodegradable polyester/polyurethane/polyureas in water. Such dispersions are known (cf.

WO 01-17347).

The powder formulations according to the invention, either as such or else after mixing with further formulation auxiliaries and/or plant treatment agents and, if appropriate, after further dilution with water, can be employed in practice. They are applied by customary methods, that is to say for example by broadcasting, pouring, spraying or atomizing.

It is especially advantageous to convert the powders according to the invention, by adding suitable formulation auxiliaries and, if appropriate, diluents, into seed-dressing products with which a wide range of seed can be treated. Thus, such seed-dressing products are suitable for dressing the seed of cereals such as wheat, barley, rye, oats and triticale, and of the seed of rice, maize, oilseed rape, peas, field beans, cotton, sunflowers and beet, or else the widest possible range of vegetable seed. The seed-dressing product formulations may also be employed for dressing the seed of transgenic plants. In this context, synergistic effects may be observed in combination with the substances formed by expression. Suitable mixing apparatus for treating the seed with the seed-dressing product formulations are all those which can conventionally be employed for the treatment of seed. Specifically, seed-dressing is done by introducing the seed into a mixer, adding the desired amount of seed-dressing product formulations either as such or after previously diluting them with water, and mixing until the formulation is distributed uniformly on the seed. If appropriate, this is followed by a drying process.

The powder formulations according to the invention and the formulations which can be prepared therefrom by further mixing with formulation auxiliaries and/or plant treatment compositions are outstandingly suitable for applying agrochemical active compounds to plants and/or their environment. They ensure that the active components are released over a prolonged period in the specific amount desired.

The rate of application of the powder formulations according to the invention and of the preparations which can be prepared therefrom by further mixing with formulation auxiliaries can be varied within a substantial range. It depends on the agrochemical active compounds which are present in each case, their content in the plant treatment compositions, the indication in question, and the field of application.

The preparation and the use of the powder formulations according to the invention is illustrated by the examples which follow.

### PREPARATION EXAMPLES

A) Preparation of Hydroxyl-Containing Polyesters

### Examples 1 to 4

Preparation of Terephthalic Polyester.

The starting materials terephthalic acid (TS), dimethyl terephthalate (DMT), 1,6-hexanediol (HD), neopentyl glycol-(NPG), 1,4-dimethylolcyclohexane (CMC) and trimethylolpropane (TMP)—were introduced into a reactor and warmed with the aid of an oil bath. After most of the materials have melted, 0.05% by weight of di-n-butyltin oxide was added at a temperature of 160° C. to act as catalyst. The first elimination of methanol occurred at a temperature of approx. 170° C. The reaction was completed within 6 to 8 hours. The polyester was cooled to 200° C., and most of the volatile components were removed within 30 to 45 minutes by applying a vacuum (10 mbar). During the entire reaction time, the bottom product was stirred, and a gentle stream of nitrogen was passed through the reaction mixture.

The composition of the polyesters obtained together with their physical and chemical characteristics are listed in Tables 1 and 2 which follow.

TABLE 1
Composition of the polyesters of Examples 1 to 4

| | Starting materials | | | | | |
|---|---|---|---|---|---|---|
| Exam- | TS | DMT | HD | NPG | DMD | TMP |
| ple | mole(s) | mole(s) | mole(s) | mole(s) | mole(s) | mole(s) |
| 1 | 11 | 11 | 9.75 | 11 | — | 2.9 |
| 2 | 10 | 10 | 6.25 | 10.5 | 2 | 2.9 |
| 3 | 12 | 12 | 8 | 10.25 | 4.5 | 2.9 |
| 4 | — | 9 | — | 4 | 3.75 | 2.5 |

TABLE 2
Chemical and physical characteristics of the polyesters of Examples 1 to 4

| Ex- | | Acid | Melting | | Viscosity at |
|---|---|---|---|---|---|
| am- | OH number | number | point | DTA | 160° C. |
| ple | mg KOH/g | mg KOH/g | ° C. | ° C. | mPa · s |
| 1 | 50-55 | 3-4 | approx. 75 | approx. 50 | ˜22000 |
| 2 | 55-60 | 2-4 | approx. 75 | approx. 50 | ˜25000 |
| 3 | 44-48 | 3-4 | approx. 75 | approx. 50 | ˜25000 |
| 4 | 100-105 | <2 | approx. 85 | approx. 59 | ˜20000 |

### Example 5

In a stirred four-necked flask apparatus, 503 g (3.03 mol) of terephthalic acid, 587.8 g (3.03 mol) of dimethyl terephthalate, 58 g (0.4 mol) of adipic acid, 686.4 g (6.6 m61) of neopentyl glycol and 32 g (0.24 mol) of trimethylolpropane were warmed slowly under nitrogen. 1 g of dibutyltin oxide was added to the melt with stirring at 160° C. Methanol and water were subsequently distilled off in the course of 7 hours at 170 to 220° C. and of 14 hours at 220° C. to 230° C. The resulting polyester had an acid number of 4.7. The melt was cooled to 200° C. and freed from volatile components within 30 minutes at 11 mbar. The melt was thereupon cooled to 160° C., and the polyester was poured onto a Teflon tray. The resulting clear yellow nonsticky resin had an acid number of 4.4 and a glass transition temperature of 55° C. (DTA).

B) Preparation of Powder Formulations According to the Invention

### Example 6

In a stirred four-necked flask apparatus, 490 g of the polyester known under the name CRYLCOAT®) 240 (UCB Chemicals/Belgium) are heated up to 150° C. and melted. 210 g of imidacloprid are introduced portionwise into the melt at 140° C. to 150° C. Stirring of the mixture is subsequently continued at 150° C. to 160° C. until a clear melt is obtained, which is poured onto a Teflon tray. The resin, which is pure and nonsticky at room temperature, is comminuted and ground finely in a jet mill without cooling. Standard electron microscopy reveals particles of a size of approx. 0.2 to 20 μm. The pulverulent polymer-bound plant treatment composition consists of 30% by weight of imidacloprid and 70% by weight of polyester.

### Example 7

In a stirred four-necked flask apparatus, 68.5 g of the polyester known under the name CRYLCOAT® 240 (UCB Chemicals/Belgium) and 1.5 g of the emulsifier known under the name Atlox® LP 6 (Uniquema) are heated to 150° C. melted. 30 g of imidacloprid are introduced into the melt at 140° C. to 150° C. Stirring of the mixture is subsequently continued at 150° C. to 160° C. until a clear melt is obtained, which is poured onto a Teflon tray. Within 20 hours, the resin, which is pure and nonsticky at room temperature, is reduced to a powder in a ball mill and screened to a particle size of <125 μm.

### Example 8

In a stirred four-necked flask apparatus, 68.5 g of the polyester known under the name CRYLCOAT® 240 (UCB Chemicals/Belgium) and 1.5 g of the emulsifier known under the name Agrimer® 22 (ISP) are heated to 150° C. and melted. 30 g of imidacloprid are introduced into the melt at 140° C. to 150° C. Stirring of the mixture is subsequently continued at 150° C. to 160° C. until a clear melt is obtained, which is poured onto a Teflon tray. Within 20 hours, the resin, which is pure and nonsticky at room temperature, is reduced to a powder in a ball mill and screened to a particle size of <125/km.

C) Use examples

### Example 9

Release of Active Compound

3531.5 mg of the powder of Example 6 are stirred in 1 litre of Cipac 500 ppm water (=Standard Water C) at 25° C. The imidacloprid amounts to 28.9% by weight of the powder employed. Accordingly, the initial weight of imidacloprid is 1020.6 mg.

Imidacloprid has a solubility in water of approximately 700 mg/litre at 25° C.

Samples are taken from the stirred mixture after the stirring times indicated in Table 3 below and are filtered through a 0.2/m microfilter. The imidacloprid concentration is determined in each of the filtrates. The active compound concentration is determined by means of HPLC:

TABLE 3

| Sampling after [h] | Imidacloprid content in |
|---|---|
| stirring | the sample [mg/l] |
| 0.25 | 24.1 |
| 0.5 | 34.1 |
| 1 | 45.7 |
| 2 | 50.52 |
| 4 | 53.15 |
| 6 | 60.73 |
| 24 | 81.72 |
| 72 | 115.0 |
| 168 | 141.30 |
| 336 | 179.50 |
| 504 | 193.7 |

The data reveal that the powder formulation according to the invention releases the active compound in a controlled manner over a prolonged period.

### EXAMPLE 10

Rice seed dressing

3.34 g of the powder formulation of Example 6 are stirred with 12 g of water, 0.4 g of sticker (Impranil DLN D50, Bayer AG) and 1 g of a 1% by weight strength aqueous solution of the colorant LEVANYL RED BB-LF (Bayer AG) to give a seed-dressing fluid. This is applied to 200 g of dehusked rice kernels cv. KOSHIHIKARA. The rice kernels treated in this way are subsequently moved by hand in a dish until the individual rice kernels no longer adhere to each other. The dressed seed is then dried for 16 hours at 40° C. All rice kernels are coated. No abrasion is observed.

### EXAMPLE 11

Rice Seed Dressing

1.67 g of the powder formulation of Example 6 and 2.5 g of a commercially available carpropamid formulation with a carpropamid content of 40% by weight are stirred with 4 g of water, 0.2 g of sticker (Impranil DLN W50, Bayer AG) and 1 g of a 1% by weight strength aqueous solution of the colorant LEVANYL RED BB-LF (Bayer AG) to give a seed-dressing fluid. This is applied to 100 g of dehusked rice kernels cv. KOSHIHIKARA. The rice kernels treated in this way are subsequently moved by hand in a dish until the individual rice kernels no longer adhere to each other. The dressed seed is then dried for 16 hours at 40° C. All rice kernels are coated. No abrasion is observed.

### Example 12

Rice Seed Dressing

In three different batches, in each case 18.5 g of rice kernels cv. Koshihikari dehusked are treated with in each case 200 μl of water in a seed-dressing apparatus. Thereafter, 55.5 μl of adhesive (Impranil DNL D 50, Bayer AG) are added to each batch. Immediately thereafter, the batches thus treated are mixed separately
a) with 123.3 mg,
b) with 246.7 mg or
c) with 616.7 mg
   of powder formulation of Example 6, with rotation. In this manner, dressed seed whose active ingredient concentration is
a) 200 g per 100 kg of seed,
b) 400 g per 100 kg of seed and
c) 1000 g per 100 kg of seed, respectively,
   is obtained. All rice kernels are coated. No abrasion is observed.

### EXAMPLE 13

Tolerance Test

Dishes 17 cm×13 cm in size whose bottom is covered with 4 cm of sieved and steamed agricultural soil are planted uniformly in each case with
in each case 18.5 g of dressed rice kernels from each of the three samples prepared as described in Example 12 or
in each case 18.5 g of rice kernels which have been treated in the same manner with a commercially available, liquid Imidacloprid seed-dressing formulation.
The rice kernels are subsequently covered with 1 cm of soil.

The dishes are then placed into a chamber in which the relative air moisture is 90% and in which a daytime temperature of 24° C. and a nighttime temperature of 15° C. prevails.

After the periods stated in Table 4 hereinbelow post-sowing, the plants are examined for damage. Features which are determined are necroses, yellowing, abnormal growth and deformation. The total of all symptoms of damage is expressed in percent. 0% means that no damage is observed, while 100% means that the plants are completely damaged.

The preparations employed, the application rates of active compound and the test results can be seen from the table which follows.

TABLE 4
Tolerance test

| | | Application rate | | | |
|---|---|---|---|---|---|
| Sample of | | of active ingredient | Total damage in % after | | |
| Example | | in g.a.i./100 kg seed | 15 days | 22 days | 29 days |
| In accordance | a) | 200 | 5 | 5 | 20 |
| with the | b) | 400 | 5 | 5 | 15 |
| invention | c) | 1000 | 15 | 10 | 30 |
| Example 12 | | | | | |

| | | | | |
|---|---|---|---|---|
| known: | 200 | 10 | 10 | 25 |
| Imidacloprid seed- | 400 | 15 | 10 | 40 |
| dressing formulation | 1000 | 35 | 60 | 75 |
| Control | 0 | 2.5 | 10 | 20 |
| (untreated) | | | | |

1-8. (canceled)

9. A powder formulation having a particle diameter of under 125 μm consisting of
(a) one or more agrochemical active compounds,
(b) one or more biodegradable hydroxyl-containing polyesters, optionally in a mixture with one or more further biodegradable polymers, and
(c) optionally, one or more additives.

10. A powder formulation according to claim 9 wherein the polyester is one or more hydroxyl-containing terephthalate acid polyesters.

11. A powder formulation according to claim 9 wherein the agrochemical active compound is selected from the group consisting of imidacloprid, carpropamid, or mixtures thereof.

12. A powder formulation according to claim 9 consisting of
(a) between 1 and 50% by weight of the agrochemical active compound,
(b) between 50 and 99% by weight of the hydroxyl-containing polyester or a mixture thereof with one or more additional polymers, and
(c) between 0 and 30% by weight of additives.

13. A Process for the preparation of powder formulations according to claim 9 comprising
(1) homogenizing in the melt at temperatures of between 50° C. and 180° C. a mixture of
(a) one or more agrochemical active compounds,
(b) one or more biodegradable hydroxyl-containing polyesters, optionally in a mixture with one or more further biodegradable polymers, and
(c) optionally, one or more additives, and
(2) comminuting the resultant mixture after cooling to obtain a powder having particles with a diameter under 125 μm.

14. A method of applying agrochemical active compounds comprising applying a powder formulation according to claim 9 to plants and/or their environment.

15. A process for the preparation of plant treatment compositions comprising mixing a powder formulation according to claim 9 with one or more extenders and/or surfactants.

16. A plant treatment composition comprising an effective amount of a powder formulation according to claim 9 in conjunction with one or more extenders and/or surfactants.
